(19) United States
(12) Patent Application Publication
(10) Pub. No.: US 2002/0050024 A1
(43) Pub. Date: May 2, 2002

(54) Brake hinge and electronic apparatus comprising the brake hinge

(76) Inventor: Tomomi Murayama, Nishitama-gun (JP)

Correspondence Address: Finnegan, Henderson, Farabow,, Garrett & Dunner, L.L.P., 1300 I Street, N.W., Washington, DC, 20005-3315, US

(21) Appl. No.: 09/955,068

(22) Filed: Sep. 19, 2001

(30) Foreign Application Priority Data
Sep. 25, 2000 (JP) 2000-291299

(51) Int. Cl. E05D 1/00; E05D 11/08

(52) U.S. Cl. 16/221

(57) ABSTRACT

A brake hinge configured to connect a main housing and a display housing, one of which is rotatable with respect to the other, and to apply a predetermined torque to the housings, has a torque-generating section shaped like a hollow cylinder. The torque-generating section comprises a first member and a second member. The first member has a first guiding path in its one end portion. The second member is aligned coaxial with the first member, holds the other end portion of the first member, allowing the first member to rotate, and has a second guiding path in its middle portion. The torque-generating section holds a middle portion of a harness that connects the main housing and the display housing. The first guiding path guides one end portion of the harness into one of the housings. The second guiding path guides the other end portion of the harness into the other of the housings.

### CROSS-REFERENCE TO RELATED APPLICATIONS

This application is based upon and claims the benefit of priority from the prior Japanese Patent Application No. 2000-291299, filed Sep. 25, 2000, the entire contents of which are incorporated herein by reference.

### BACKGROUND OF THE INVENTION

1. Field of the Invention

The present invention relates to a brake hinge configured to couple a panel to the housing of, for example, an electronic apparatus. More particularly, the invention relates to a brake hinge for use in portable personal computers (hereinafter referred to as “notebook PC”) and a notebook PC comprising such brake hinges.

2. Description of the Related Art

A notebook PC comprises a main housing, a keyboard, and a display housing. The main housing contains various components. The keyboard is provided on the upper surface of the main housing. The display housing is coupled to the rear side of the housing. The display housing comprises a liquid crystal display (LCD) and incorporates an inverter. A mask member is laid on the LCD.

In most cases, two brake hinges are provided at the junction between the main housing and the display housing. One brake hinge is located near the left side of the main housing, and the other brake hinge near the right side of the main housing. The space between the brake hinges accommodates a sub-LCD and speakers.

A harness electrically connects the LCD and the inverter, both incorporated in the display housing, to the components incorporated in the main housing. The harness extends through one of the brake hinges, which is shaped like a hollow cylinder. The harness is connected, at one end, to the component provided in the main housing and, at the other end, to the LCD and the inverter.

The harness protrudes from both ends of the brake hinge. One end portion of the harness projects from one side of the notebook PC if this brake hinge is located near that side of the notebook PC. The brake hinge needs to be provided near the midpoint between the sides of the notebook PC.

If one of the brake hinges is provided near the midpoint, the space between the hinges will be too small to accommodate the sub-LCD and the speakers. To increase this space to hold the sub-LCD and the speakers, the notebook PC has to be broad.

Namely, any notebook PC comprising conventional brake hinges has but low freedom of design.

### BRIEF SUMMARY OF THE INVENTION

The present invention has been made in view of the foregoing. An object of the invention is to provide a brake hinge that helps reduce the size of an electronic apparatus and increase the freedom of design thereof. Another object of the invention is to provide an electronic apparatus that comprises such brake hinges.

To achieve the first-mentioned object, a brake hinge according to the invention is designed to connect two housings, one being rotatable with respect to the other, and to apply a predetermined torque to the housings. The brake hinge comprises: a first harness-guiding path provided at one end of the brake hinge; a second harness-guiding path provided at a middle part of the brake hinge; and a torque-generating section shaped like a hollow cylinder and connecting the first and second harness-guiding paths. The torque-generating section holds a middle portion of a harness. The first harness-guiding path guides one end portion of the harness into one of the housings. The second harness-guiding path guides the other end portion of the harness into the other housing.

To attain the second-mentioned object, an electronic apparatus according to the invention has a main housing containing components and a display housing holding a display section and rotatably coupled to the main housing. The electronic apparatus comprises a brake hinge and a harness. The brake hinge connects the main housing and the display housing and apples a predetermined torque thereto. The brake hinge comprises a first harness-guiding path provided at one end of the brake hinge, a second harness-guiding path provided at a middle part of the brake hinge, and a torque-generating section shaped like a hollow cylinder and connecting the first and second harness-guiding paths. The harness electrically connects the display section and the components. The harness comprises a middle portion held in the torque-generating section of the brake hinge. One end portion of the harness is guided into one of the housings by the first harness-guiding path. The other end portion of the harness is guided into the other housing by the second harness-guiding path.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently embodiments of the invention, and together with the general description given above and the detailed description of the embodiments given below, serve to explain the principles of the invention.

FIG. 1 is a perspective view of an electronic apparatus comprising brake hinges according to an embodiment of the invention, showing the display housing set in an opened position;

FIG. 2 is a perspective view of the electronic apparatus, showing the display housing set in the closed opened position;

FIG. 3 is a perspective view of the electronic apparatus, with the cover member and the mask member removed from the main housing and the display housing, respectively;

FIG. 4 is a perspective view of a part of the electronic apparatus, showing the harness that connects the components provided in the main housing to the components provided in the display housing;

FIGS. 5A and 5B are perspective views of a brake hinge according to an embodiment of the present invention; and

FIG. 6 is a sectional view illustrating in detail that part of the electronic apparatus that is shown in FIG. 4.

### DETAILED DESCRIPTION OF THE INVENTION

An embodiment of the invention will be described in detail, with reference to the accompanying drawings.

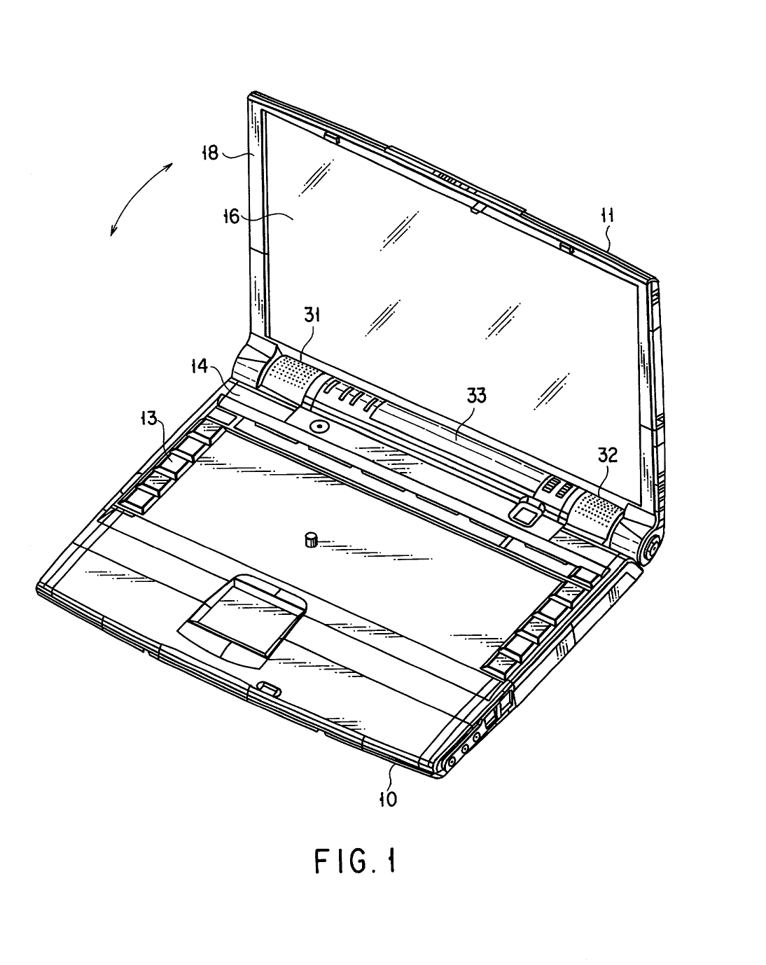

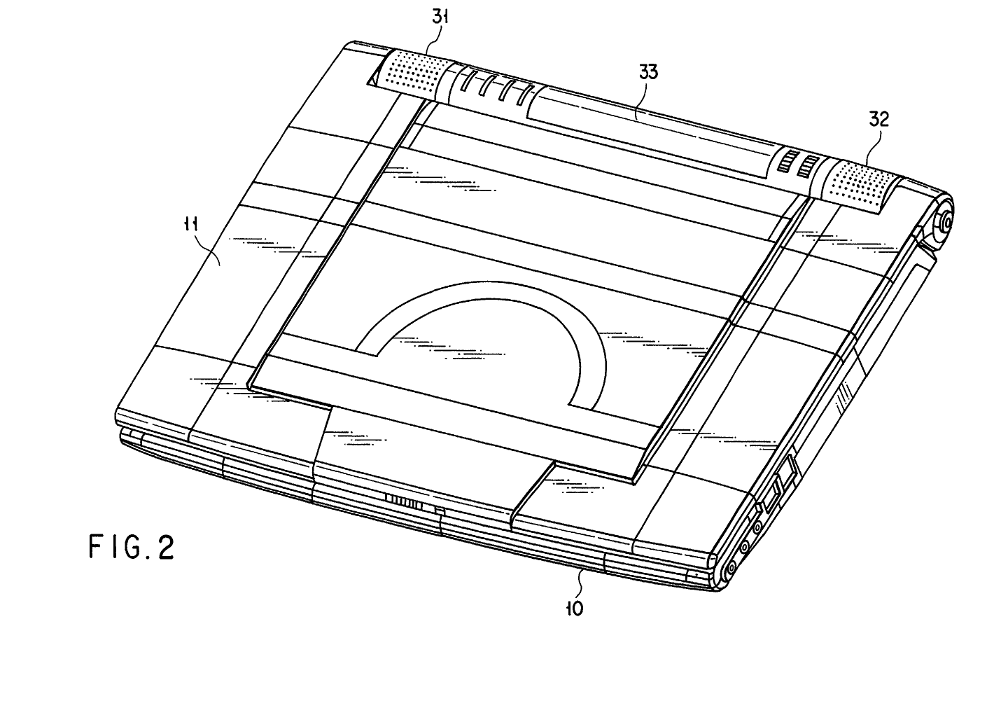

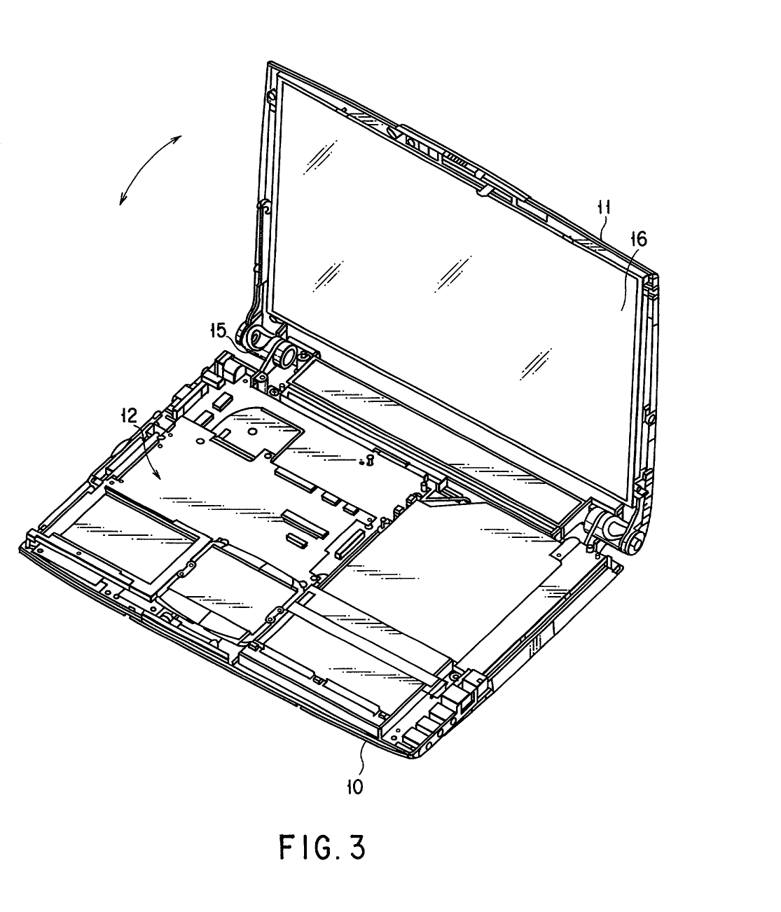

FIGS. 1 to 3 show a portable personal computer (hereinafter referred to as “notebook PC”) that comprises brake hinges according to an embodiment of the invention. FIG. 1 is a perspective view of the notebook PC, showing the display housing 11 set in an opened position. FIG. 2 is a perspective view showing the display housing 11 set in the closed position. FIG. 3 is a perspective view of the notebook PC, with the cover member 14 and the mask member 18 removed from the main housing 10 and the display housing 11, respectively.

The main housing 10 contains main units 12 including, for example, a printed wiring board. A keyboard 13 for inputting data when operated is arranged on the main housing 10. The cover member 14 shaped like a frame is mounted on the main housing 10. The frame-shaped cover member 14 exposes the keyboard 13 so that a user may operate the keyboard 13.

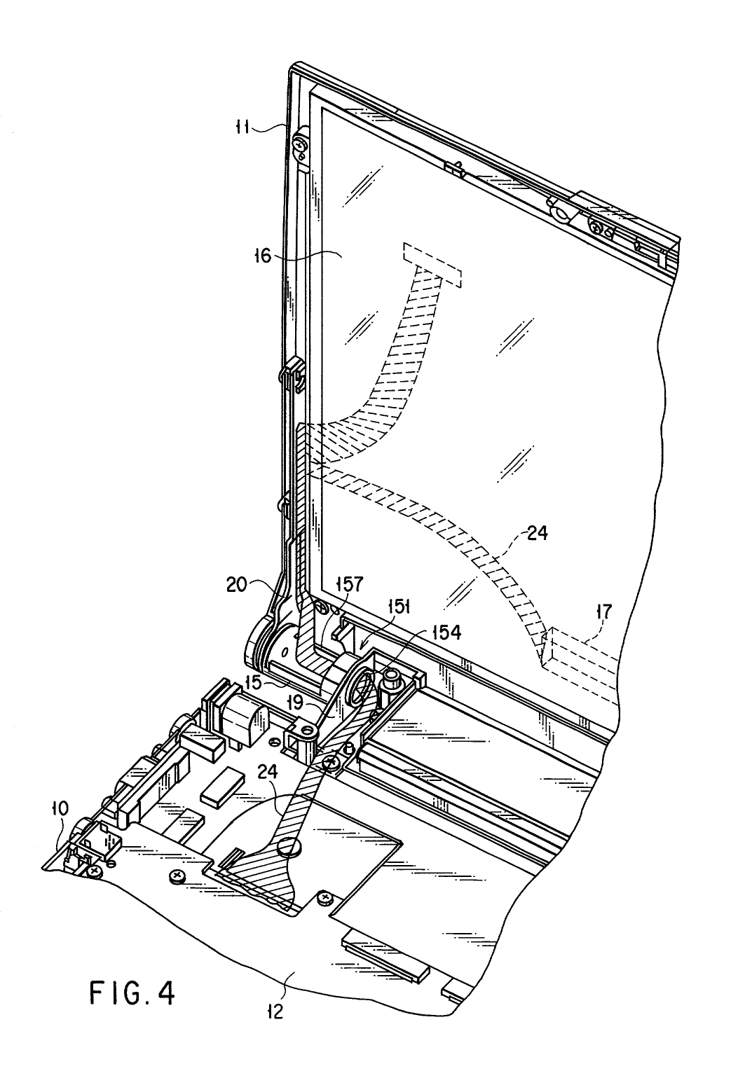

The display housing 11 holds, for example, a liquid crystal display (LCD) 16. As shown in FIG. 4, the display housing contains an inverter 17. The LCD 16 and the inverter 17 constitute the display section of the notebook PC. The mask member 18, which is shaped like a frame, is mounted on the LCD 16.

Two brake hinges 15 are provided at the junction between the main housing 10 and the display housing 11. The brake hinges 15 couple the display housing 11 to the rear side of the main housing 10. The display housing 11 can be rotated around the common axis of the brake hinges 15, in the directions shown in arrows in FIG. 1. The display housing 11 covers the keyboard 13 when it is rotated onto the main housing 10 to the closed position.

The brake hinges 15 will be described with reference to FIGS. 4 to 6.

The two brake hinges 15 are spaced apart from for a prescribed distance, located near the left and right sides of the notebook PC, respectively. In the present invention, the brake hinges are partly exposed at the left and right sides of the notebook PC. The brake hinges 15 are identical in structure. Hereinafter, only the hinge 15, which is provided at the left side of the notebook PC and guides a harness 24, will be described.

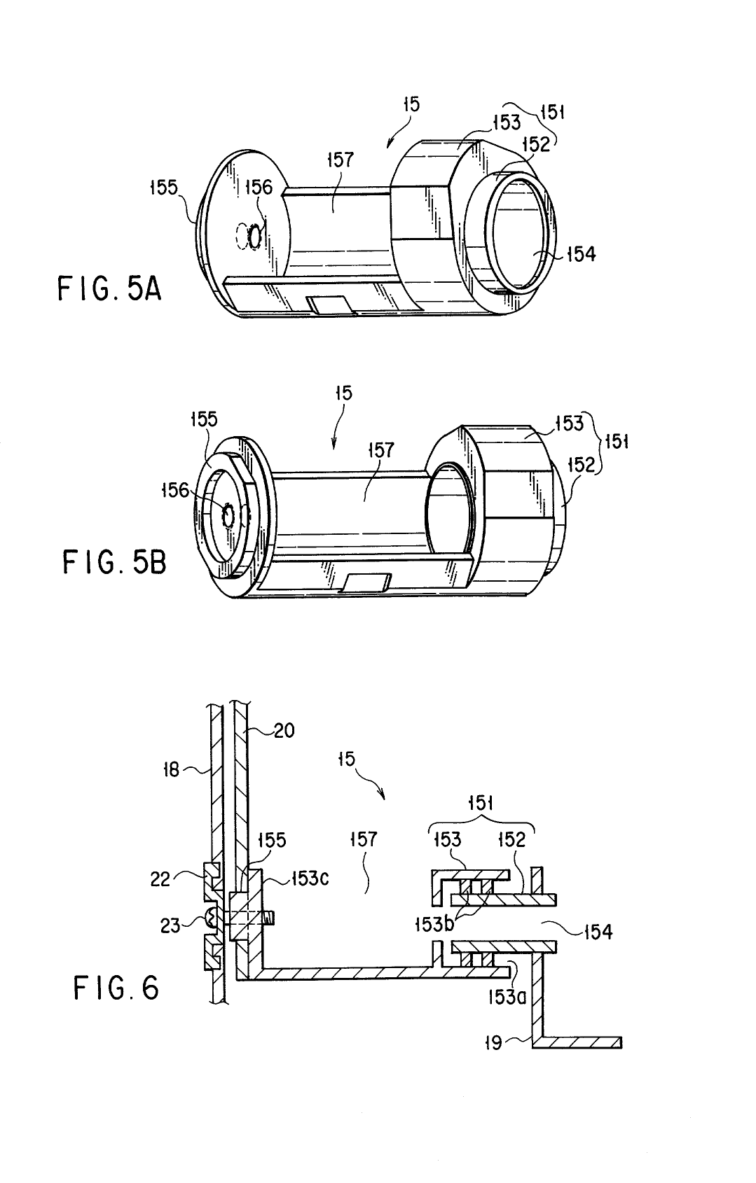

As FIGS. 5A and 5B show, the brake hinge 15 comprises a torque-generating section 151, which is a hollow cylinder. The section 151 has two rotary members 152 and 153. The second rotating member 153 is mounted on the first rotary member 152 and positioned coaxial thereto. When rotated in the opposite directions, the rotary members 152 and 153 generate a predetermined torque.

As FIG. 6 shows, the first rotary member 152 is shaped like a hollow cylinder. The rotary member 152 has a through hole, which functions as first harness-guiding path 154. The first rotary member 152 has its right end secured to a plate 19 by means of, for example, calking. The plate 19 is in turn secured to the main housing 10. Thus, the plate 19 fastens the first rotary member 152 to the main housing 10.

The second rotary member 153 has its right-end portion 153a mounted on the left-end portion of the first rotary member 152. Two annular projections 153b protrude from the inner circumferential surface of the right-end portion 153a. The projections 153b are set in frictional contact with the outer circumferential surface of the left-end portion of the first rotary member 152. The annular projections 153b serve to generate a torque. Alternatively, an elastic member such as a so-called “wave washer” may be interposed between the rotary members 152 and 153, thereby to generate a torque.

The second rotary member 153 is closed at its left end 153c. A disk 155 is mounted on and secured to the closed end 153c of the second rotary member 153. A plate 20 is secured to the circumferential surface of the disk 155 by means of, for example, a calking. The plate 20 is in turn secured to the display housing 11. Hence, when the user rotates the display housing 11, the second rotary member 153 will be rotated, too.

The middle part of the second rotary member 153, which extents between the annular projections 153b and the closed end 153c, is shaped like a trough. It communicates with the first harness-guiding path 154 made in the first rotary member 152 and functions as second harness-guiding path 157. That is, the middle part of the member 153 connects the first harness-guiding path 154 and the second harness-guiding path 157.

The disk 155 secured to the closed end 153c of the second rotary member 153 has a screw hole 156 in its center part. The disk 155 is exposed at the left side of the notebook PC. The screw hole 156 may be used to attach various components to the display housing 11.

In the present embodiment, a fastener 22 is secured to the display housing 11 by driving a screw 23 into the screw hole 156. Thus secured to the housing 11, the fastener 22 positions the mask member 18 with respect to the LCD 16. Other members need not be used to position the mask member 18 with respect to the LCD 16.

The brake hinge 15 having the structure described above set in place at the junction between the main housing 10 and the display housing 11. More specifically, the plate 19 fixed to the first rotary member 152 is secured to the main housing 10. Thus, the plate 19 fastens the first rotary member 152 to the main housing 10 by means of screws or the like. The plate 20 fixed to the second rotary member 153 is then secured to the display housing 11 by means of screws or the like. The brake hinge 15 is thereby set in place. The brake hinge 15 couples the display housing 11 to the main housing 10, allowing the former to rotate with respect to the latter. As the user rotates the display housing 11 with respect to the main housing 10, the brake hinge 15 generates a predetermined torque.

As shown in FIG. 4, the middle portion of the harness 24 rests in the torque-generating section 151 of the brake hinge 15. One end of the harness 24 is guided into the main housing 10 through the first harness-guiding path 154 and electrically connected to the main units 12 provided in the main housing 10. The other end of the harness 24 is guided via the second harness path 157 into the display housing 11, extending at right angles to the axis of the brake hinge 15. In the display housing 11, the other end of the harness 24 is electrically connected to the LCD 16 and the inverter 17. The middle portion of the harness 24 does not exist outside the main housing 10 or the display housing 11.

When the user rotates the display housing 11 with respect to the main housing 10 in the direction of either arrow shown in FIG. 1, the torque-generating section 151 of the brake hinge 15 generates a constant torque or a changing torque. The torque holds the display housing 11 at an opened position shown in FIG. 1, or at the closed position shown in FIG. 2.

In the embodiment, the brake hinge 15 is closed at the outer end and the harness 24 has an end portion guided into the display housing 11 from the middle part of the brake hinge 15. Thus, that end portion of the harness 24 is not pulled from the outer end of the hinge 15 as with the conventional brake hinge. Hence, the outer end of the hinge 15 can be exposed at the left side of the notebook PC. This means that the hinge 15 can be positioned at the very left side of the notebook PC. If the hinge 15 is so positioned, a large space will be provided between the two brake hinges 15. Speakers 31 and 32 and a sub-LCD 33 can be arranged in this space, as illustrated in FIGS. 1 and 2.

In other words, a relatively large space can be provided between the brake hinges 15 even if the notebook PC has a comparatively small width. Thus, the brake hinges 15 according to the invention help to enhance the freedom of design of the notebook PC.

In the embodiment, one end portion of the harness 24, which is led from the second harness path 157, is guided into the display housing 11. Instead, this end portion of the harness 24 may be guided into the main housing 10.

In the embodiment described above, two brake hinges 15 are provided at the junction between the main housing 10 and the display housing 11. The number of hinges provided is not limited to two. Brake hinges can be provided in any desired numbers.

In the embodiment, the fastener 22 is secured to the display housing 11 by using the screw 23, thus positioning the mask member 18 at the other end of the second rotary member 153. Instead of the fastener 22, a carrying belt or any other accessory may be attached to the other end of the second rotary member 153. If accessories are attached to the other end of the second rotary member 153, the notebook PC will be more useful than the conventional notebook PCs.

In the embodiment, the brake hinge 15 has only a single second harness path 157. Nonetheless, the brake hinge 15 may have two second harness paths that intersect at about right angles with the axis of the brake hinge 15.

The embodiment described above is a notebook PC comprising the main housing 10 and the keyboard 13 mounted on the housing 10. The present invention is not limited to a notebook PC. Rather, it can be applied to any other types of electronic apparatuses.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A brake hinge for connecting two housings, one being rotatable with respect to the other, and for applying a predetermined torque to the housings, said hinge comprising:
a first harness-guiding path provided at one end of the brake hinge;
a second harness-guiding path provided at a middle part of the brake hinge; and
a torque-generating section shaped like a hollow cylinder and connecting the first and second harness-guiding paths,
wherein the torque-generating section holds a middle portion of a harness, the first harness-guiding path guides one end portion of the harness into one of the housings, and the second harness-guiding path guides the other end portion of the harness into the other housing.

2. The brake hinge according to claim 1, the other end of which is exposed at one side of the housings.

3. The brake hinge according to claim 2, further comprising an accessory-fastening structure provided at the end exposed at one side of the housings.

4. The brake hinge according to claim 1, wherein the torque-generating section comprises:
a first rotary member having the first harness-guiding path in one end portion; and
a second rotary member aligned coaxial with the first rotary member, configured to apply a predetermined torque to the first rotary member and having the second harness-guiding path in a middle portion.

5. The brake hinge according to claim 4, wherein the first rotary member is secured to one of the housings, and the second rotary member is secured to the other of the housings.

6. The brake hinge according to claim 5, wherein the second rotary member is exposed at the one side of the housings.

7. The brake hinge according to claim 6, further comprising an accessory-fastening structure provided at the end exposed at one side of the housings.

8. An electronic apparatus having a main housing containing components and a display housing holding a display section and rotatably coupled to the main housing, said apparatus comprising:
a brake hinge connecting the main housing and the display housing, configured to apply a predetermined torque thereto, and comprising a first harness-guiding path provided at one end of the brake hinge, a second harness-guiding path provided at a middle part of the brake hinge, and a torque-generating section shaped like a hollow cylinder and connecting the first and second harness-guiding paths; and
a harness electrically connecting the display section and the components and comprising a middle portion held in the torque-generating section of the brake hinge, one end portion guided into one of the housings by the first harness-guiding path and the other end portion guided into the other housing by the second harness-guiding path.

9. The electronic apparatus according to claim 8, wherein the torque-generating section comprises:
a first rotary member having the first harness-guiding path in one end portion; and
a second rotary member aligned coaxial with the first rotary member, configured to apply a predetermined torque to the first rotary member and having the second harness-guiding path in a middle portion.

10. The electronic apparatus according to claim 9, wherein the first rotary member is secured to one of the housings, and the second rotary member is secured to the other of the housings.

11. The electronic apparatus according to claim 10, wherein the second rotary member is exposed at the one side of the main housing and display housing.

12. The brake hinge according to claim 11, further comprising an accessory-fastening structure provided at the end exposed at one side of the housings.

13. The electronic apparatus according to claim 9, wherein the display housing is secured to the second rotary member and a mask member of the display section is fastened to the second rotary member and positioned by a positioning member.
